(19) United States
(12) Patent Application Publication
(10) Pub. No.: US 2025/0107660 A1
(43) Pub. Date: Apr. 3, 2025

(54) Grill Heat Extractor

(71) Applicant: Dansons US, LLC, Scottsdale, AZ (US)

(72) Inventors: Perini Valla Malla, Phoenix, AZ (US); Justin Johnson, Gilbert, AZ (US)

(73) Assignee: Dansons US, LLC, Scottsdale, AZ (US)

(21) Appl. No.: 18/898,676

(22) Filed: Sep. 27, 2024

Related U.S. Application Data
(60) Provisional application No. 63/541,668, filed on Sep. 29, 2023.

(51) Int. Cl. A47J 37/07; F24C 15/32

(52) U.S. Cl. CPC A47J 37/0786; A47J 37/0718; F24C 15/322

(57) ABSTRACT

A heat extractor for a grill having a cooking chamber includes an outer housing and a cap over the outer housing, together cooperating to bound an outer chamber, wherein the outer chamber is coupled to an environment through a vent. An extraction assembly is disposed within the outer chamber and bounds a plenum. The extraction assembly is for controlling movement of air from the cooking chamber into the plenum and out of the plenum into the outer chamber. The extraction assembly includes a motor, a carousel mounted to the motor for rotation within the plenum, an intake grill for admitting air into the plenum, and a damper assembly for emitting air out of the plenum. The carousel is mounted for rotation to draw air through the intake grill, into the plenum, and out the damper assembly.

### CROSS-REFERENCE TO RELATED APPLICATIONS

This application claims the benefit of U.S. Provisional Application No. 63/541,668, filed Sep. 29, 2023, which is hereby incorporated by reference in its entirety.

### FIELD

The present specification relates generally to cooking appliances, and more particularly to grills and smokers.

### BACKGROUND

Cooking appliances such as grills, smokers, and the like are enormously popular for cooking meat, vegetables, and many other types of food. Typically, grills are used to cook food at high temperatures in short amounts of time by heating or searing the food on the hot rack of the grill. Smokers usually cook food at lower temperatures for longer times, using smoke to imbue food with rich flavors. Grilling or smoking food gives the food qualities that are difficult to replicate with other cooking appliances.

There are many different types of grills and smokers, such as those that rely on charcoal, propane, or pellets as a fuel source. Pellet grills and smokers burn wood pellets to create the heat and smoke with which food is cooked. As the pellets burn, they heat the grill or smoker's cooking chamber and fill it with smoke. Charcoal grills burn charcoal briquettes or lumps to create high temperatures within the grill. And propane ignites to produce a flame directly from a gas tube to heat the grill and its interior space.

Heat is important while cooking, and while cooks want their grills to be hot, they do not want them to be uncontrollably hot. As such, most conventional grills have vents to exhaust air from the cooking chamber. Exhausting air removes heat from the cooking chamber to lower the interior temperature.

Typically, the vents are manual vents, such as a series of slits or slots with a damper. The cook can adjust the damper to a desired setting which she believes will exhaust heat to keep the cooking chamber at a desired temperature.

Unfortunately, precise control of the cooking chamber nevertheless remains difficult. It is hard to properly adjust the damper to achieve the desired temperature without experience. It is also a challenge to determine when the cooking chamber's temperature has steadied or is rising or falling and whether to further adjust the damper based on that status. Further, environmental factors, such as the moving sun, the wind, changing temperatures during the day, and other factors can require the cook to return to her post, check the temperature, and adjust the vents. These problems are magnified when grilling over long periods of time, such as an entire day. An improved system and method for controlling the temperature of the cooking chamber is needed.

### SUMMARY

In an embodiment of a heat extractor for a grill having a cooking chamber, the heat extractor includes an outer housing and a cap over the outer housing, together cooperating to bound an outer chamber, wherein the outer chamber is coupled to an environment through a vent. An extraction assembly is disposed within the outer chamber and bounds a plenum. The extraction assembly is for controlling movement of air from the cooking chamber into the plenum and out of the plenum into the outer chamber. The extraction assembly includes a motor, a carousel mounted to the motor for rotation within the plenum, an intake grill for admitting air into the plenum, and a damper assembly for emitting air out of the plenum. The carousel is mounted for rotation to draw air through the intake grill, into the plenum, and out the damper assembly.

In embodiments, the intake grill separates the plenum from the cooking chamber. The vent is open, the intake grill is open, and the damper assembly is adjustable between open and closed positions. The extraction assembly further includes a table having a top plate and a sidewall, wherein the top plate, the sidewall, and the intake grill bound and define the plenum. The carousel has an open bottom, a conical top, and a plurality of louvers at a perimeter. The carousel rotates about an axis of rotation, and the louvers are mounted parallel to the axis of rotation. Each of the louvers is aligned in a transverse fashion with respect to a radii extending outward from the axis of rotation to the respective louver.

In an embodiment of a heat extractor for a grill for controlling a flow of air from a cooking chamber in the grill, the heat extractor includes an intake grill having a plurality of openings for mounting over the cooking chamber. A table is disposed over the intake grill. The table and the intake grill bound and define a plenum configured for fluid communication with the cooking chamber through the plurality of openings. A carousel is mounted for rotation within the plenum to control the flow of air through the plurality of openings and out of the table. A damper assembly surrounds the table and includes an adjustable gate moveable between an open position and a closed position, wherein in the open position, the flow of air is directed out of the gate and out of the heat extractor, and in the closed position, the flow of air is directed into an outer chamber within the heat extractor. The outer chamber is bound and defined within an outer housing of the heat extractor. The outer housing is configured to be secured onto the grill and surrounding the intake grill, the table, the plenum, the carousel, and the damper assembly. A vent is formed in the outer housing to enable the flow of air from the outer chamber to an environment.

In embodiments, the intake grill separates the plenum from the cooking chamber. The vent and the intake grill are normally open. The carousel has an open bottom, a conical top, and a plurality of louvers at a perimeter. The carousel rotates about an axis of rotation, and the louvers are mounted parallel to the axis of rotation. Each of the louvers is aligned in a transverse fashion with respect to a radii extending outward from the axis of rotation to the respective louver.

In an embodiment of a heat extractor for a grill for controlling a flow of air from a cooking chamber in the grill, the heat extractor includes an outer housing configured to be fixed to the cooking chamber so as to define an outer chamber outside of the cooking chamber, and the outer housing is vented. A plenum is within the outer chamber and is bound by a top plate, an opposed intake grill, and a damper assembly. The intake grill is configured to couple the plenum in fluid communication with the cooking chamber, and the damper assembly couples the plenum in fluid communication with the outer chamber. A carousel is mounted within the plenum, and a motor assembly is operably coupled to impart rotation to the carousel at one of a plurality of speeds in response to a temperature within the cooking chamber.

In embodiments, the carousel has an open bottom, a conical top, and a plurality of louvers at a perimeter. The carousel rotates about an axis of rotation, and the louvers are mounted parallel to the axis of rotation. The outer housing has an open top, and a cap is mounted above the open top. The damper assembly includes a housing completely encircling the plenum except at a gate, where the damper assembly includes an adjustable baffle to control the flow of air from the plenum into the outer chamber. The gate is radially spaced apart from the table between opposed ends of the housing, thereby defining a horizontal gap in the damper assembly allowing the flow of air vertically out of the plenum into the outer chamber. The motor assembly includes a motor disposed in the outer chamber and outside of the plenum.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a front perspective view of a grill fit with a heat extractor;

FIG. 2 is a partially-exploded perspective view of the heat extractor;

FIG. 3 is a section view of the heat extractor taken along the line 3-3 in FIG. 1;

FIG. 4 is a top perspective section view of the heat extractor taken along the line 4-4 in FIG. 3;

FIG. 5 is a top perspective section view of the heat extractor taken along the oblique line 5-5 in FIG. 3; and

FIG. 6 is a top perspective section view of the heat extractor taken along the line 6-6 in FIG. 3.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

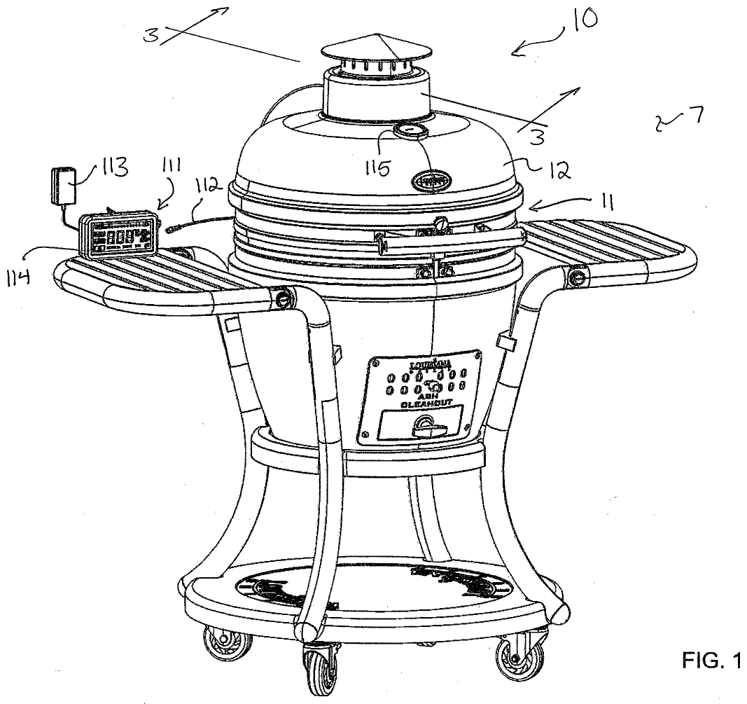

FIG. 1 is a front perspective view of a grill 11 fit with a heat extractor 10. The grill 11 is merely exemplary of a grill, a smoker, and the like, and this disclosure is not limited to the form of grill shown in these drawings. The grill 11 includes a top or lid 12 covering a cooking chamber. The heat extractor 10 sits atop the grill 11 to draw and then exhaust hot air from within the grill 11 to effectively regulate the temperature of the cooking chamber of the grill 11.

This specification describes a heat extractor 10 which is mounted to the lid 12 of the grill 11. In preferred embodiments, the lid 12 is manufactured with the heat extractor 10 attached thereto for distribution and sale therewith, while in other embodiments, the user may add the heat extractor 10 to the lid 12 after the grill 11 is manufactured and sold, or the grill 11 may be modified after purchase to accommodate the heat extractor 10. All of these variations of manufacture and assembly are within the scope of this specification.

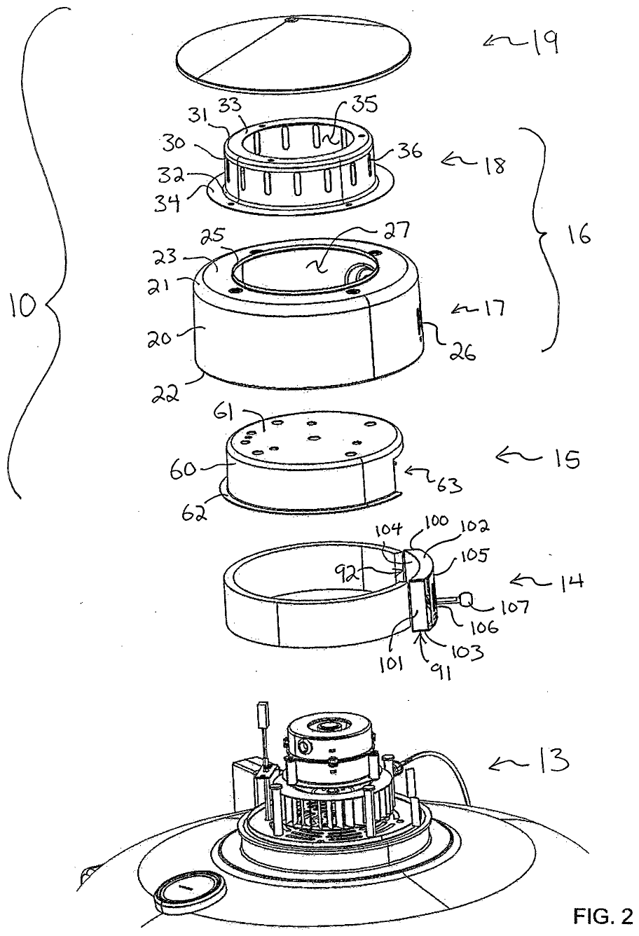

FIG. 2 is a partially-exploded perspective view of the heat extractor 10. Starting near the bottom of the drawing and moving upward, the heat extractor 10 includes an extraction assembly 13, a damper assembly 14, a table 15, an outer housing 16 including a lower shroud 17 and an upper vent or shroud 18, and a cap 19.

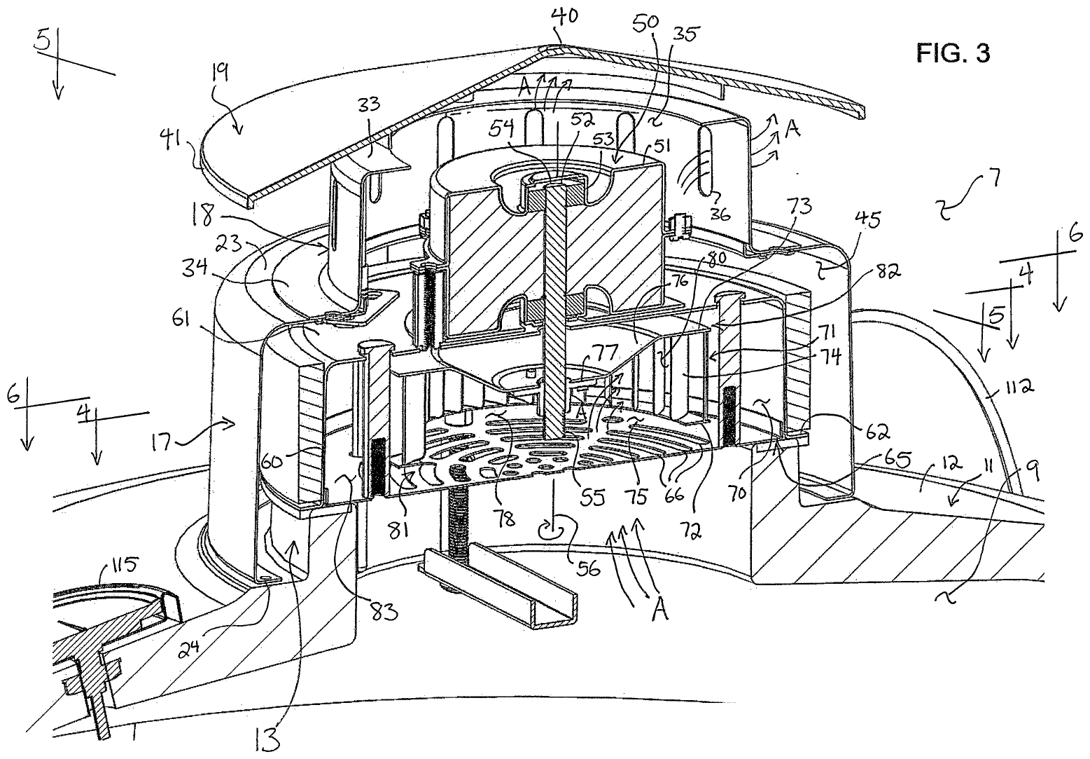

The outer housing 16 is shown clearly in FIG. 2 and in the section view of FIG. 3, taken along the line 3-3 in FIG. 1. The outer housing 16 is set on the lid 12 of the grill 11. The lid 12 overlies the cooking chamber 9, the large open space inside the grill 9 where food is heated and cooked. In the embodiment shown here, the outer housing 16 is fixed to the lid 12, such as by rivets. In other embodiments, the outer housing 16 may be set upon the lid 12 over an opening into the cooking chamber 9, formed integrally and monolithically as part of the lid 12, or otherwise secured to the lid 12. The outer housing 16 includes both the lower shroud 17 and the upper shroud 18.

The lower shroud 17 includes a cylindrical outer sidewall 20 extending between a top 21 and an opposed bottom 22. The sidewall 20 is thin and single-walled. At the top 21, the sidewall 20 turns radially inward to form an inwardly-directed upper lip 23. At the bottom 22, the sidewall 20 turns radially inward to form an inwardly-directed lower lip 24. The upper lip 23 is larger than the lower lip 24. The upper lip 23 extends further inward than does the lower lip 24, and it terminates at an upstanding rim 25. The rim 25 bounds a large central opening 27.

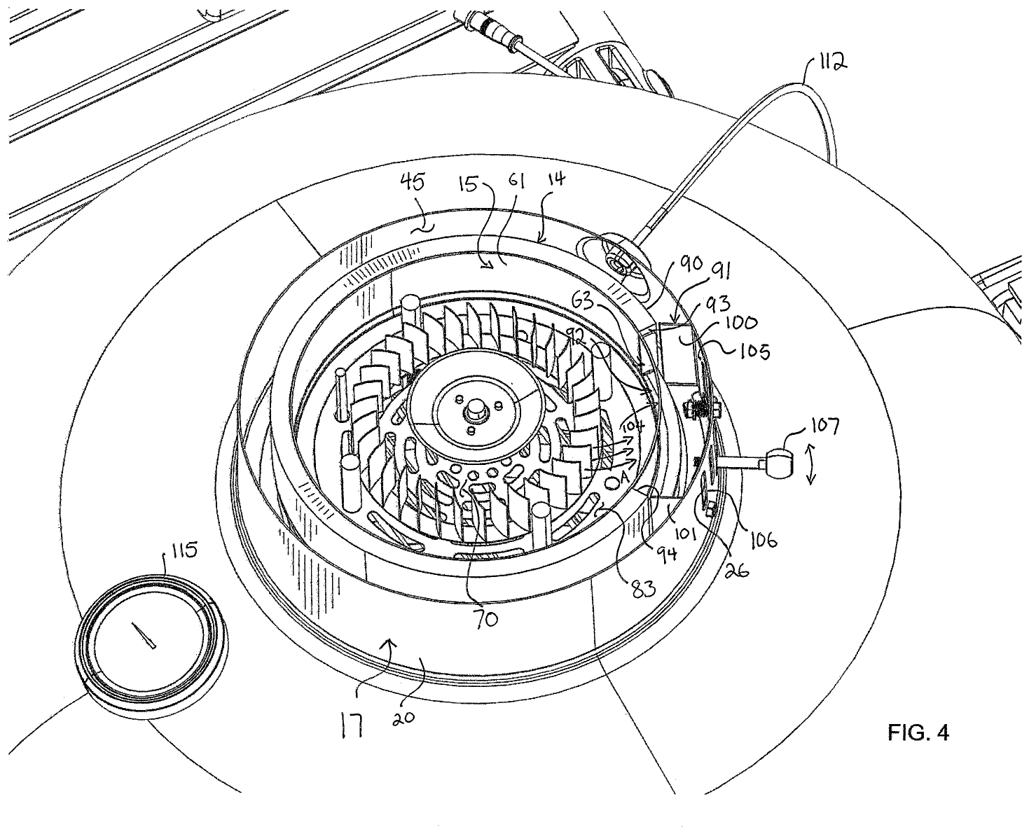

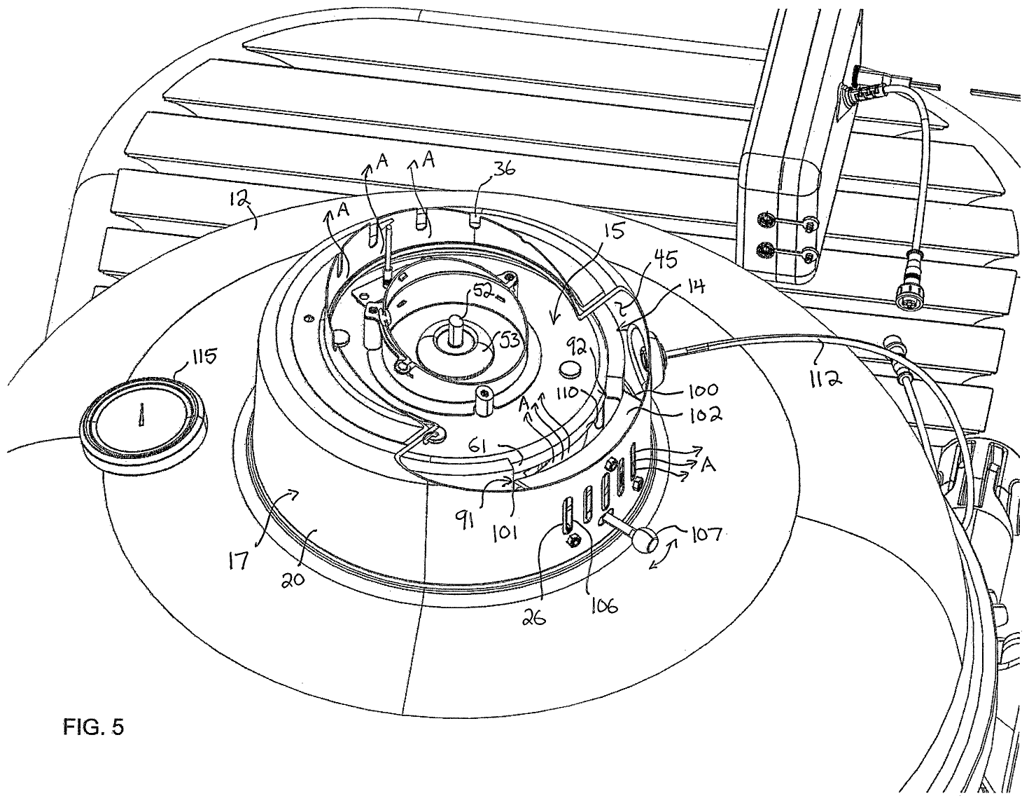

As shown slightly in FIG. 2, but better illustrated in FIGS. 4 and 5, there are several slots 26 in the sidewall 20. In this embodiment, there are five slots 26, but this number is neither critical nor limiting. The slots 26 are vertically oriented and laterally or circumferentially spaced apart. These slots 26 are one type of vent in the outer housing 16, and they are normally open.

The upper shroud 18 is on top of the lower shroud 17. In the embodiment shown here, the upper shroud 18 is fixed to the lower shroud 17, such as by rivets. In other embodiments, the upper shroud 18 is formed integrally and monolithically to the lower shroud 17, while in other embodiments, the upper shroud 18 is snap-fit onto the lower shroud 17 or otherwise secured thereto.

The upper shroud 18 includes a cylindrical outer sidewall 30 extending between a top 31 and an opposed bottom 32. The sidewall 30 is thin and single-walled. At the top 31, the sidewall 30 turns radially inward to form an inwardly-directed upper lip 33. At the bottom 32, the sidewall 30 turns radially outward to form a lower lip 34. The lower lip 34 of the upper shroud 18 is secured to the upper lip 23 of the lower shroud 17. The upper lip 33 bounds a large central opening 35 just slightly smaller in diameter than the central opening 27 of the lower shroud 17 below. This central opening 35 is another type of vent in the outer housing 16, and it is normally open.

There are a number of slots 36 in the sidewall 30. The slots 36 are vertically oriented and laterally or circumferentially spaced apart across the entire sidewall 30. These slots 36 are another type of vent in the outer housing 16, and they are normally open.

Referring now to FIG. 3, the cap 19 is mounted to the upper shroud 18. The cap 19 has a low, wide, conical shape extending from a tip 40 to a perimeter edge 41. The cap 19 extends radially outward over the central opening 35, over the upper shroud 18, and over the lower shroud 17, such that the outer diameter of the perimeter edge 41 is just slightly larger than the outer diameter of the lower shroud 17. The perimeter edge 41 also hangs down vertically below the top 31 of the upper shroud 18. The interior of the cap 19 is preferably substantially empty but for mounting hardware connecting the cap 19 to the upper shroud 18.

When the outer housing 16 and cap 19 are mounted to the lid 12, the cap 19 cooperates with the lower shroud 17 and the upper shroud 18 to bound and define an outer chamber 45 outside of the cooking chamber 9 of the grill 11. The outer chamber 45 defines an interior space of the heat extractor 10. All air rising from the cooking chamber 9 into the heat extractor 10 eventually passes into the outer chamber 45, and all such air eventually leaves the outer chamber 45 and passes into the environment 7 through the slots 26 in the lower shroud 17, through the slots 36 in the upper shroud 18, or through the central opening 35 at the top 31 of the upper shroud 18. Before that air passes into the environment 7, however, it can be retained within the outer chamber 45 and controllably released therefrom.

Carried within the outer chamber 45 is the extraction assembly 13, as shown in FIG. 3. The extraction assembly 13 includes a motor assembly 50 including a motor 51, an inner rotor shaft 52, and upper and lower bushings 53 or bearings on which the rotor shaft 52 is mounted for rotation. The shaft 52 has opposed ends: an upper end 54 and a lower end 55. The upper end 54 is carried in the upper bushing 53, and the lower end 54 is free. The shaft 52 is also supported along its length by the lower bushing 53. The shaft 52 defines an axis 56 of rotation.

The motor assembly 50 is mounted to and above the table 15. The table 15 is shown well in both FIGS. 2 and 3. It has a flat top plate 60 and a cylindrical sidewall 61 that extends downward from the top plate 60. The sidewall 61 is continuous but for a rectangular opening 63 seen in FIG. 2. At the bottom of the sidewall 61, the sidewall 61 flares radially outward to define a short flange 62. The damper assembly 14 is mounted on this flange 62.

Under the table 15, and flush with the flange 62, is an intake grill 65. The intake grill 65 spans the circular space under the table 15 and within the flange 62. The intake grill 65 is preferably flat and circular, and it has a large number of openings or slots 66 formed entirely through the intake grill 65.

The slots 66 are arranged in a pattern defining an outer diameter. In this embodiment, the slots 66 have arcuate configurations arranged in radially spaced-apart concentric portions of circles. In other words, the slots 66 are in the form of short arcuate sections, spaced apart from each other radially and circumferentially. The slots 66 closer to the geometric center of the intake grill 65 are shorter arcs, and the slots 66 further from the geometric center are longer arcs. The outermost slots define this outer diameter of the slots 66 collectively.

The table 15 and the intake grill 65 cooperate to bound and define a plenum 70. The plenum 70 is joined in free fluid communication with the cooking chamber 9 immediately below the intake grill 65 through the slots 66, but the intake grill 65 nonetheless defines a separation between the cooking chamber 9 and the plenum 70. When the grill 11 is operating, heated air rises from within the cooking chamber 9 of the grill 11, through the slots 66, and into the plenum 70. From the plenum 70, this heated air exhausts through the opening 63, as is described in more detail below.

The rotor shaft 52 of the motor assembly 50 extends down from the motor 51, through a hole in the top plate 60 of the table 15, and into the plenum 70. Within the plenum 70 is a carousel 71 mounted on the rotor shaft 52 for rotation within the plenum 70 about the axis 56 of rotation. The carousel 71 controllably draws a flow of air from the cooking chamber 9, through the slots 66, and into the plenum 70, and then directs it out of the table 15 and through the rest of the heat extractor 10.

The carousel 71 includes a lower plate 72, an upper plate 73, and a plurality of louvers 74 extending between the lower and upper plates 72 and 73. The carousel 71 has an outer diameter corresponding to the outer diameter of the slots 66. The bottom of the carousel 71 is open, and an interior 78 of the carousel 71 is empty. As such, substantially all of the heated air rising through the slots 66 enters into the interior 78 of the carousel 71.

The lower plate 72 of the carousel 71 is annular with a wide circular opening 75 in its middle roughly as wide as the outer diameter of the slots 66. The upper plate 73 is roughly disc-shaped and includes a central socket 76 that depends downwardly away from the table 15. The socket 76 terminates centrally at a hub 77, which receives the rotor shaft 52. The lower end 55 of the rotor shaft 52 is just below the hub 77.

The louvers 74 are set along the perimeter of the carousel 71, extending vertically between the lower plate 72 and the upper plate 73. Each of the louvers 74 is a curved blade and is parallel to the axis 56 of rotation. The louvers 74 are spaced apart from each other so as to define gaps 80 between adjacent louvers 74.

Each louver 74 is preferably angled at an offset relation with respect to a radius extending outward from the geometric center of the carousel 71. In other words, each of the louvers 74 is aligned in a transverse fashion with respect to a particular radii extending outward from the axis 56 of rotation of the carousel 71 to the that particular louver 74.

When the motor 51 operates, the rotor shaft 52 rotates and imparts rotation to the carousel 71. The socket 76 is secured just above the free lower end 55 of the rotor shaft 52 at the hub 77. The lower plate 72 is spaced above the intake grill 65 by a gap 81, and the upper plate 73 is spaced below the plate 60 of the table 15 by a gap 82 as well. Rotation of the carousel 71 draws heated air up from the cooking chamber 9, through the slots 66 of the grill 11, into the plenum 70, and then into the interior 78 of the carousel 71. The heated air is then directed generally laterally out through the spinning louvers 74. The outer diameter of the carousel 71 is less than the inner diameter of the sidewall 61, so the outer edge of the carousel 71 is spaced radially inward from the sidewall 61 of the table 15. As such, heated air is pushed into an annular space 83 between the carousel 71 and the sidewall 61. This annular space 83 is a thin, annular section of the larger plenum, proximate the sidewall 61 of the table 15.

The sidewall 61 of the table 15 completely encloses the side of the plenum 70 except in one section, at the opening 63. The opening 63 of the sidewall 61 is illustrated in FIG. 4. The opening 63 is rectangular, preferably extending from the bottom of the sidewall 61 to the top of the sidewall 61 and having an arc length of approximately one-eight of the perimeter of the sidewall 61. Hot air can pass out of the plenum 70 though the opening 63.

The damper assembly 14 laterally surrounds the table 15. The damper assembly 14 is adjustable between open and closed positions and helps controllably release the hot air passing out of the plenum 70. The damper assembly 14 includes a cylindrical housing 90 and a gate 91. Like the sidewall 61 of the table 15, the housing 90 encircles and extends nearly continuously around the plenum 70 except at a lateral gap or opening 92. The gate 91 is located at this opening 92.

The housing 90 is coextensive to the height of the sidewall 61. It has opposed ends 93 and 94 which are spaced apart from each other and cooperate to define the opening 92 in the housing 90. That opening 92 is coextensive to and registers with the opening 63 in the sidewall 61. Thus, the thin sidewall 61 of the table 15 has an opening 63 and the thicker housing 90 of the damper assembly 14 has a corresponding opening 92. The openings 63 and 92 are registered and thus cooperate to form a passage from the plenum 70 and the annular space 83 near the inner surface of the sidewall 61.

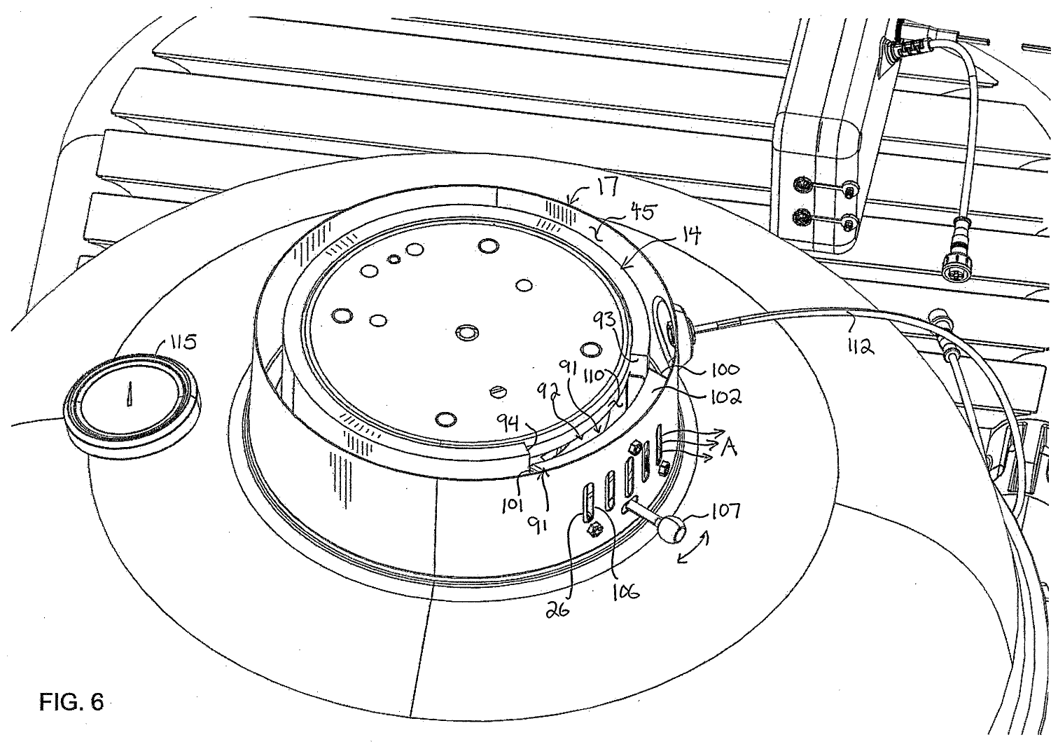

Just beyond, or outside of, the opening 63 is the gate 91. The gate 91 helps control the amount of heated air exhausted from the heat extractor 10. As shown in FIGS. 2, 5, and 6, the gate 91 is an arcuate prismatic box having opposed closed ends 100 and 101, a closed top 102 and closed bottom 103, an inner opening 104, and an exterior baffle panel 105 opposite the inner opening 104. The exterior baffle panel 105 has slots 106 and is mounted for sliding lateral movement in the box of the gate 91, controllable by a handle 107 projecting forwardly. In some embodiments, the baffle panel 105 is spring loaded, so that the handle 107 must be depressed or pulled out before the baffle panel 105 will unlock for movement.

The damper assembly 14 is located in the outer chamber 45 inside the lower shroud 17, and the gate 91 is positioned just behind the slots 26 in the lower shroud. The handle 107 extends through the lower shroud 17, so that the user can move the handle left and right (along the arcuate double-arrowed line in FIGS. 4, 5, and 6) to selectively align or misalign the slots 106 in the gate 91 with the slots 26 in the sidewall 20 of the lower shroud 117, thereby opening or closing one of the vents of the heat extractor 10.

Other than at the gate 91, the lower shroud 17 is radially spaced apart from damper assembly 14 and is vertically spaced apart from the table 15, creating an offset space. This offset space is part of the outer chamber 45, and it can be seen clearly in FIGS. 4, 5, and 6. In embodiments, the outer chamber 45 is preferably isolated from fluid communication with the plenum 70 except at the opening 92 of the damper assembly 14. There, because the gate 91 is radially spaced apart from the sidewall 61 of the table 15, is a small horizontal gap 110 formed in the opening 92 between the sidewall 61 and the top of the gate 91. This gap 110 is the only connection between the plenum 70 and the outer chamber 45.

The flow of air is shown in the various figures as three curved arrowed lines marked with the reference character A. Heated air can pass through the gap 110: heated air can move from the plenum 70 outwardly the annular space 83, and then from the annular space 83 into the outer chamber 45 through this gap 110. Heated air rising up from the gap 110 is in the outer chamber 45, where it is between the extraction assembly 13 and the outer housing 16. Because it is hot, the air rises within the outer chamber 45 and leaves the heat extractor 10 through the slots 36 or the central opening 35 in the upper shroud 18.

When the user opens the gate 91, heated air from the plenum 70 passes through the opening 63, through the opening 92, and through the gate 91 to exit the heat extractor 10 through the slots 26, as shown with the three curved arrowed lines marked with the reference character A. When the user closes the gate 91, the air can only leave the heat extractor 10 by rising upward and then out through the slots 36 or central opening 35. Setting the gate 91 to a position between fully open and fully closed allows some heated air to escape through the gate 91 and the rest to exit through the upper shroud 18.

The heat extractor 10 includes, and is controlled by, a controller 111, shown best in FIG. 1. A cable 112 extends from the controller 111 through the lower shroud 17 and to the motor 51. The cable 112 is connected to the controller 111 to power, control, and transmit and receive data to and from the motor 51 and other elements of the heat extractor 10.

The controller 111 may be powered by battery or, as shown in FIG. 1, with a plug 113 to an AC electrical source such as an electrical outlet. The controller 111 includes a human-readable display 114, such as an LCD display or touch-screen display, which shows operational information about the heat extractor 10 as well as receives input from the user. The controller 111 can operate in manual or automatic modes.

Preferably, the display 114 displays at least temperature and speed readings for the heat extractor 10. The temperature is measured preferably by a thermocouple inside the heat extractor 10 or, in some embodiments, inside the cooking chamber of the grill (though there is also analog thermometer 115). In other embodiments, a probe can be connected to the heat extractor 10 for measuring the internal temperature of a piece of food.

Speed corresponds to a “fan” speed or relative rotational speed of the carousel 71 spinning on the rotor shaft 52 of the motor 51. The display 114 preferably also includes a set of buttons for turning the heat extractor 10 on, adjusting the fan speed, setting the desired temperature (of the grill 11 or of the food in the grill 11), and switching the temperature display between Celsius and Fahrenheit. A hard button is a physical button that can be depressed, while a soft button is a button presented on the touch-screen display which is responsive to the touch of a finger. The display 114 can also display a “Low Fuel” warning or a probe problem indication.

The user preferably interacts with the controller 111 to adjust the operation of the heat extractor 10. In some embodiments, the controller 111 additionally includes a network interface so that it can communicate with other devices through the Internet, Wifi, Bluetooth, ZigBee, and other communication networks and protocols. For example, a user can operate the controller 111 through an application on her phone, mobile device, or computer, so long as that application has established a communication connection with the controller 111 through the network interface. This allows the user to run the heat extractor 10 and both monitor and control the temperature of the cooking chamber of the grill 11 remotely, such as from inside a house, from a neighbor's house or backyard, or from across the city or elsewhere.

In operation of the heat extractor 10, the user must turn the controller 111 on by pressing its power button. Preferably, the controller 111 defaults to automatic operation. In automatic operation, the user sets the desired temperature on the controller 111. If the desired temperature is above a threshold temperature or temperature differential, the motor 51 spins at no more than a maximum rotational rate, preferably below 100% of its maximum speed.

The controller 111 contains logic and systems feedback. The probe and/or thermocouple records the temperature and the controller 111 receives that temperature. The controller 111 uses PID control to adjust the speed of the motor 51 to reach and then maintain the desired temperature. This continues until the user turns the controller 111 off, changes the desired temperature, or changes the controller 111 to manual mode.

In manual mode, the user sets the fan speed using the buttons to increment or decrement the rotational speed of the carousel 71. The motor 51 will continue to rotate at the selected speed until the user changes the fan speed or turns the controller 111 off.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A heat extractor for a grill having a cooking chamber, the heat extractor comprising:
an outer housing and a cap over the outer housing, together cooperating to bound an outer chamber, wherein the outer chamber is coupled to an environment through a vent; and
an extraction assembly disposed within the outer chamber and bounding a plenum, the extraction assembly for controlling movement of air from the cooking chamber into the plenum and out of the plenum into the outer chamber;
wherein the extraction assembly includes a motor, a carousel mounted to the motor for rotation within the plenum, an intake grill for admitting air into the plenum, and a damper assembly for emitting air out of the plenum; and
the carousel is mounted for rotation to draw air through the intake grill, into the plenum, and out the damper assembly.

2. The heat extractor of claim 1, wherein the intake grill separates the plenum from the cooking chamber.

3. The heat extractor of claim 1, wherein the vent is open, the intake grill is open, and the damper assembly is adjustable between open and closed positions.

4. The heat extractor of claim 1, wherein the extraction assembly further includes a table having a top plate and a sidewall, wherein the top plate, the sidewall, and the intake grill bound and define the plenum.

5. The heat extractor of claim 1, wherein the carousel has an open bottom, a conical top, and a plurality of louvers at a perimeter.

6. The heat extractor of claim 5, wherein the carousel rotates about an axis of rotation, and the louvers are mounted parallel to the axis of rotation.

7. The heat extractor of claim 6, wherein each of the louvers is aligned in a transverse fashion with respect to a radii extending outward from the axis of rotation to the respective louver.

8. A heat extractor for a grill for controlling a flow of air from a cooking chamber in the grill, the heat extractor comprising:
an intake grill including a plurality of openings for mounting over the cooking chamber;
a table disposed over the intake grill, the table and the intake grill bounding and defining a plenum configured for fluid communication with the cooking chamber through the plurality of openings;
a carousel mounted for rotation within the plenum to control the flow of air through the plurality of openings and out of the table;
a damper assembly surrounding the table, the damper assembly including an adjustable gate moveable between an open position and a closed position, wherein in the open position, the flow of air is directed out of the gate and out of the heat extractor, and in the closed position, the flow of air is directed into an outer chamber within the heat extractor;
the outer chamber is bound and defined within an outer housing of the heat extractor, the outer housing configured to be secured onto the grill and surrounding the intake grill, the table, the plenum, the carousel, and the damper assembly; and
a vent formed in the outer housing to enable the flow of air from the outer chamber to an environment.

9. The heat extractor of claim 8, wherein the intake grill separates the plenum from the cooking chamber.

10. The heat extractor of claim 8, wherein the vent and the intake grill are normally open.

11. The heat extractor of claim 8, wherein the carousel has an open bottom, a conical top, and a plurality of louvers at a perimeter.

12. The heat extractor of claim 11, wherein the carousel rotates about an axis of rotation, and the louvers are mounted parallel to the axis of rotation.

13. The heat extractor of claim 12, wherein each of the louvers is aligned in a transverse fashion with respect to a radius extending outward from the axis of rotation to the respective louver.

14. A heat extractor for a grill for controlling a flow of air from a cooking chamber in the grill, the heat extractor comprising:
an outer housing configured to be fixed to the cooking chamber so as to define an outer chamber outside of the cooking chamber, wherein the outer housing is vented;
a plenum within the outer chamber, the plenum bound by a top plate, an opposed intake grill, and a damper assembly, wherein the intake grill is configured to couple the plenum in fluid communication with the cooking chamber, and the damper assembly couples the plenum in fluid communication with the outer chamber;
a carousel mounted within the plenum; and
a motor assembly operably coupled to impart rotation to the carousel at one of a plurality of speeds in response to a temperature within the cooking chamber.

15. The heat extractor of claim 14, wherein the carousel has an open bottom, a conical top, and a plurality of louvers at a perimeter.

16. The heat extractor of claim 15, wherein the carousel rotates about an axis of rotation, and the louvers are mounted parallel to the axis of rotation.

17. The heat extractor of claim 14, wherein the outer housing has an open top, and a cap is mounted above the open top.

18. The heat extractor of claim 14, wherein the damper assembly includes a housing completely encircling the plenum except at a gate, where the damper assembly includes an adjustable baffle to control the flow of air from the plenum into the outer chamber.

19. The heat extractor of claim 18, wherein the gate is disposed between opposed ends of the housing, thereby defining a horizontal gap in the damper assembly allowing the flow of air vertically out of the plenum into the outer chamber.

20. The heat extractor of claim 14, wherein the motor assembly includes a motor disposed in the outer chamber and outside of the plenum.
